(19) United States
(12) Patent Application Publication
(10) Pub. No.: US 2013/0194221 A1
(43) Pub. Date: Aug. 1, 2013

(54) RESIN FILM WITH PRESSURE-SENSITIVE ADHESIVE LAYER, LAMINATED FILM, AND TOUCH PANEL

(71) Applicants: Katsunori Takada, Ibaraki-shi (JP); Daigoro Nakagawa, Ibaraki-shi (JP); Hiroyuki Takao, Ibaraki-shi (JP); Takayuki Adachi, Ibaraki-shi (JP); Hiroki Kuramoto, Ibaraki-shi (JP)

(72) Inventors: Katsunori Takada, Ibaraki-shi (JP); Daigoro Nakagawa, Ibaraki-shi (JP); Hiroyuki Takao, Ibaraki-shi (JP); Takayuki Adachi, Ibaraki-shi (JP); Hiroki Kuramoto, Ibaraki-shi (JP)

(73) Assignee: NITTO DENKO CORPORATION, Ibaraki-shi, Osaka (JP)

(21) Appl. No.: 13/877,138

(22) PCT Filed: Sep. 28, 2011
(86) PCT No.: PCT/JP2011/072235

§ 371 Date: Mar. 29, 2013

(30) Foreign Application Priority Data
Sep. 29, 2010 (JP) 2010-219292

(51) Int. Cl. C09J 7/02; G06F 3/041

(52) U.S. Cl. CPC C09J 7/0207; G06F 3/0412
USPC 345/173; 428/212

(57) ABSTRACT

A resin film with pressure-sensitive adhesive layer of the invention includes a first transparent resin film, an oligomer blocking layer, and a pressure-sensitive adhesive layer laminated in this order, wherein the oligomer blocking layer is a cured layer formed by curing a composition containing a curable compound and inorganic oxide particles, the oligomer blocking layer has a thickness of 120 nm or more, the oligomer blocking layer has a refractive index difference of 0.04 or less from the pressure-sensitive adhesive layer, and an anchoring strength between the oligomer blocking layer and the pressure-sensitive adhesive layer is 1 N/25 mm or more.

The resin film with pressure-sensitive adhesive layer can prevents the oligomer blocking layer from causing interference fringes, in which even when made thin, the oligomer blocking layer satisfies the requirements including oligomer blocking properties and scratch resistance, and also has good adhesion to the pressure-sensitive adhesive layer.

### TECHNICAL FIELD

The invention relates to a resin film with pressure-sensitive adhesive layer including a first transparent resin film, an oligomer blocking layer, and a pressure-sensitive adhesive layer, which are laminated in this order. The resin film with pressure-sensitive adhesive layer to be used may further include a functional layer laminated on the first transparent resin film. For example, these resin film with pressure-sensitive adhesive layers are each used to form a laminated film, which includes the resin film with pressure-sensitive adhesive layer and a second transparent resin film laminated thereon with the pressure-sensitive adhesive layer interposed therebetween. The laminated film can be used in various applications such as optical applications.

For example, when the second transparent resin film has a transparent conductive thin layer, the laminated film can be used as a laminate of transparent conductive film. The transparent conductive film can be used to form a transparent electrode for a display such as a liquid crystal display or an electroluminescence display or for a touch panel such as an optical, ultrasonic, capacitance, or resistive touch panel. In addition, the transparent conductive film can be used for electromagnetic wave shielding or prevention of static buildup on transparent products and to form liquid crystal dimming glass products, transparent heaters, etc.

### BACKGROUND ART

Touch panels produced using a transparent conductive film as an electrode can be classified according to the position sensing method into an optical type, a capacitance type, a resistive type, and others. Resistive touch panels are configured to include a transparent conductive film and a transparent conductor-carrying glass plate, which are arranged opposite to each other with spacers interposed therebetween, in which an electric current is allowed to flow through the transparent conductive film, while the voltage at the transparent conductor-carrying glass plate is measured.

Concerning the transparent conductive film, there has been proposed a transparent conductive laminated film including a conductive film having a transparent film substrate and a transparent conductive thin layer provided on one surface of the substrate; and a transparent base material that has a hard coating layer as an outer surface layer and is bonded to the other surface of the transparent film substrate with a pressure-sensitive adhesive layer interposed therebetween so that the laminated film can withstand scratching or taps during pressing operation (Patent Document 1).

When the transparent conductive laminated film is incorporated into an electronic device such as a touch panel, a lead is provided at an end of the transparent conductive layer using a silver paste. For example, such a lead is formed by a method including heating a conductive paste at about 100 to 150° C. for about 1 to 2 hours to cure the paste.

Unfortunately, there is a problem in that when a transparent resin film such as a polyethylene terephthalate film is used as a transparent film substrate to form a transparent conductive laminated film, low-molecular-weight components (oligomers) in the transparent film substrate can be precipitated by heating to whiten the transparent conductive laminated film. To solve this problem, it has been proposed that an oligomer blocking layer should be provided on the transparent film substrate (Patent Documents 2 and 3).

### PRIOR ART DOCUMENTS

### Patent Documents

Patent Document 1: JP-B1-2667686

Patent Document 2: JP-A-07-013695

Patent Document 3: JP-A-2003-246972

### SUMMARY OF THE INVENTION

### Problems to be Solved by the Invention

However, it has been found that when an oligomer blocking layer is provided on a transparent film substrate as mentioned above, the problem of interference fringes occurs due to variations in the thickness of the oligomer blocking layer. It has been found that particularly when a thin oligomer blocking layer is formed, interference fringes occur significantly. On the other hand, as electronic devices such as touch panels have been made thinner, transparent conductive laminated films also have been required to be thinner.

It is an object of the invention to provide a resin film with pressure-sensitive adhesive layer that includes a first transparent resin film, an oligomer blocking layer, and a pressure-sensitive adhesive layer laminated in this order, and prevents the oligomer blocking layer from causing interference fringes, in which even when made thin, the oligomer blocking layer satisfies the requirements including oligomer blocking properties and scratch resistance, and also has good adhesion to the pressure-sensitive adhesive layer.

It is another object of the invention to provide a laminated film produced using the resin film with pressure-sensitive adhesive layer and to provide a touch panel produced using the laminated film as a transparent conductive film.

### Means for Solving the Problems

In order to solve the problems described above, the inventors have made investigations, as a result, it has been found that the object can be achieved using the features described below so that the invention has been completed.

The invention relates to a resin film with pressure-sensitive adhesive layer, including a first transparent resin film, an oligomer blocking layer, and a pressure-sensitive adhesive layer laminated in this order,

wherein the oligomer blocking layer is a cured layer formed by curing a composition containing a curable compound and inorganic oxide particles,

the oligomer blocking layer has a thickness of 120 nm or more,

the oligomer blocking layer has a refractive index difference of 0.04 or less from the pressure-sensitive adhesive layer, and

an anchoring strength between the oligomer blocking layer and the pressure-sensitive adhesive layer is 1 N/25 mm or more.

In the resin film with pressure-sensitive adhesive layer, the inorganic oxide particles may be used particles where a polymerizable unsaturated group-containing organic compound bonded to the inorganic oxide particles.

In the resin film with pressure-sensitive adhesive layer, the inorganic oxide particles preferably includes silica particles.

The resin film with pressure-sensitive adhesive layer is preferably used even when the oligomer blocking layer has a thickness of less than 1 μm.

In the resin film with pressure-sensitive adhesive layer, further may include functional layer provided on a side of the first transparent resin film opposite to the first transparent resin film side where the oligomer blocking layer is provided. The resin film with pressure-sensitive adhesive layer may include a hard coating layer as the functional layer.

In the resin film with pressure-sensitive adhesive layer, the pressure-sensitive adhesive layer is preferably an acrylic pressure-sensitive adhesive layer.

In the resin film with pressure-sensitive adhesive layer, the composition for forming the oligomer blocking layer may contains 0.01 to 10 parts by weight of second particles with an average particle size of 300 nm to 2 μm other than the inorganic oxide particles based on 100 parts by weight of the curable compound, in addition to the curable compound and the inorganic oxide particles. The second particles preferably have a refractive index difference of 0.1 or less from the average of the refractive indices of the curable compound and the inorganic oxide particles.

The invention also related to a laminated film including the resin film with pressure-sensitive adhesive layer and a second transparent resin film bonded thereto with the pressure-sensitive adhesive layer of the resin film with pressure-sensitive adhesive layer interposed therebetween.

In the laminated film, the second transparent resin film may be a transparent conductive film comprising a transparent conductive layer provided, directly or with an undercoat layer interposed therebetween, on one side of the second transparent resin film opposite to the second transparent resin film side where the pressure-sensitive adhesive layer is bonded.

The invention also related to a touch panel comprising the laminated film including the transparent conductive film.

### Effect of the Invention

In the resin film with pressure-sensitive adhesive layer of the invention, the oligomer blocking layer is a cured layer formed by curing a composition containing inorganic oxide particles and a curable compound, and the oligomer blocking layer has a thickness of 120 nm or more, so that the oligomer blocking layer satisfactorily functions, specifically, has a satisfactory level of oligomer blocking properties. Thus, even when the resin film with pressure-sensitive adhesive layer is heat-treated, oligomers in the first transparent resin film are prevented from precipitating into the pressure-sensitive adhesive layer, so that whitening of the resin film with pressure-sensitive adhesive layer can be suppressed and that a good appearance can be maintained. Since the oligomer blocking layer is a cured layer, the oligomer blocking layer has the required level of hardness and a satisfactory level of scratch resistance. In addition, since the oligomer blocking layer is a cured layer (produced using an organic material as the curable compound), the anchoring strength between the oligomer blocking layer and the pressure-sensitive adhesive layer is 1 N/25 mm or more, so that the adhesion between the layers is good and that the adhesion against moisture is also good.

In a conventional resin film with pressure-sensitive adhesive layer, interference fringes occur due to variations in the thickness of an oligomer blocking layer. According to the invention, such interference fringes are reduced by adjusting the refractive index difference between the oligomer blocking layer and the pressure-sensitive adhesive layer to 0.04 or less. In the invention, the oligomer blocking layer is formed as a cured layer. Thus, even when formed with a thickness of less than 1 μm, the oligomer blocking layer is prevented from causing interference fringes, while having a satisfactory level of functions (oligomer blocking properties and scratch resistance). The oligomer blocking layer with a thickness of less than 1 μm is preferred in view of a reduction in thickness and also in view of suppressing curling.

### BRIEF DESCRIPTION OF THE DRAWINGS

FIG. 1A is a cross-sectional view showing an exemplary embodiment of the resin film with pressure-sensitive adhesive layer of the invention.

FIG. 1B is a cross-sectional view showing an exemplary embodiment of the resin film with pressure-sensitive adhesive layer of the invention.

FIG. 2A is a cross-sectional view showing an exemplary embodiment of the laminated film of the invention.

FIG. 2B is a cross-sectional view showing an exemplary embodiment of the laminated film of the invention.

### MODE FOR CARRYING OUT THE INVENTION

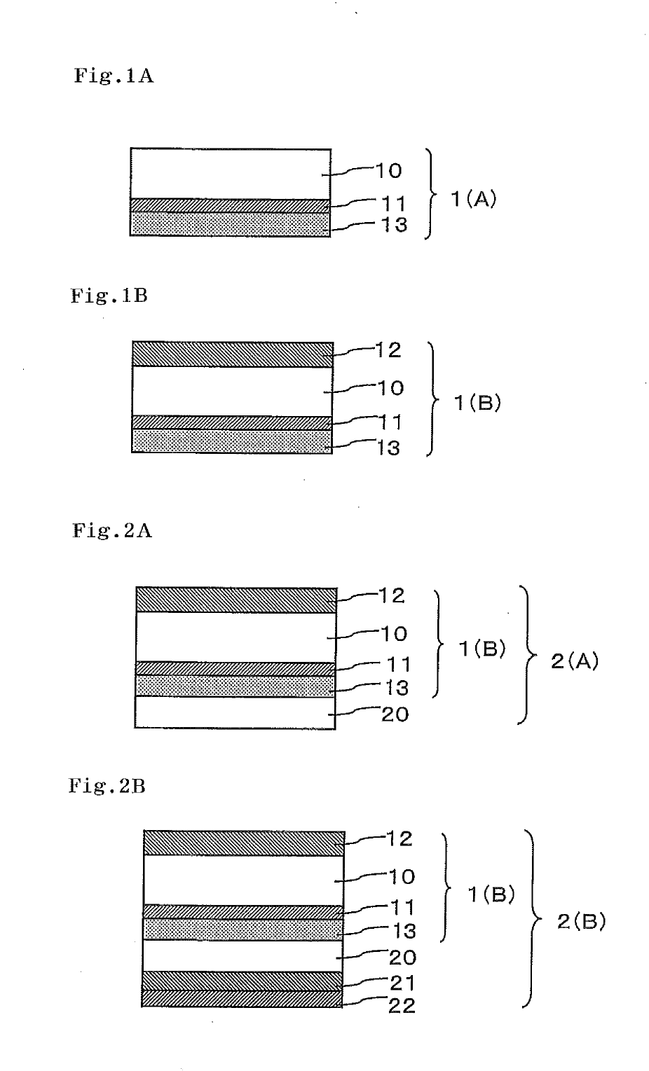

An embodiment of the resin film with pressure-sensitive adhesive layer of the invention and an embodiment of the laminated film of the invention are described with reference to the drawings. FIGS. 1A and 1B are cross-sectional views showing examples of the resin film with pressure-sensitive adhesive layer of the invention 1. As shown in FIG. 1A or 1B, the resin film with pressure-sensitive adhesive layer 1(A) or 1(B) is a laminate including a first transparent resin film 10, an oligomer blocking layer 11, and a pressure-sensitive adhesive layer 13 laminated in this order. The resin film with pressure-sensitive adhesive layer 1(A) may further include a functional layer 12 (for example, a hard coating layer). For example, FIG. 1B shows such a case in which the resin film with pressure-sensitive adhesive layer 1(B) includes the resin film with pressure-sensitive adhesive layer 1(A) of FIG. 1A and a functional layer 12 provided on the side of the first transparent resin film 10 opposite to the first transparent resin film 10 side where the oligomer blocking layer 11 is placed. In this case, the functional layer 12, the first transparent resin film 10, the oligomer blocking layer 11, and the pressure-sensitive adhesive layer 13 are laminated in this order. The resin film with pressure-sensitive adhesive layer 1(B) has the functional layer 12 as the outermost layer on the side opposite to the pressure-sensitive adhesive layer 13.

Alternatively, for example, the functional layer 12 may be provided between the oligomer blocking layer 11 and the pressure-sensitive adhesive layer 13.

FIGS. 2A and 2B are cross-sectional views showing examples of the laminated film 2 of the invention. FIG. 2A shows a laminated film 2(A) including the resin film with pressure-sensitive adhesive layer 1(B) shown in FIG. 1B and a second transparent resin film 20 placed on the pressure-sensitive adhesive layer 13 of the resin film with pressure-sensitive adhesive layer 1(B). FIG. 2B shows a laminated film 2(B) including the laminated film 2(A) shown in FIG. 2A, an undercoat layer 21, and a transparent conductive layer 22 provided on the side of the second resin film 20 opposite to the second resin film 20 side where the pressure-sensitive adhesive layer 13 is bonded, wherein the undercoat layer 21 is interposed between the second transparent resin film 20 and the transparent conductive layer 22. The laminated film 2(B) of FIG. 2B can be used as a transparent conductive film. In FIG. 2B, the transparent conductive layer 22 is provided on the second transparent resin film 20 with the undercoat layer 21 interposed therebetween. Alternatively, the transparent conductive layer 22 may be provided directly on the second transparent resin film 20 without the undercoat layer 21 interposed therebetween. FIGS. 2A and 2B show cases where the laminated film 2 includes the resin film with pressure-sensitive adhesive layer 1(B) shown in FIG. 1B. However, the resin film with pressure-sensitive adhesive layer 1 used to form the laminated film 2 is not limited to the resin film with pressure-sensitive adhesive layer 1(B) shown in FIG. 1B and may be of any other type such as the resin film with pressure-sensitive adhesive layer 1(A) shown in FIG. 1A.

First, a description is given of the resin film with pressure-sensitive adhesive layer 1(A) of the invention. The resin film with pressure-sensitive adhesive layer 1 includes a first transparent resin film 10 and an oligomer blocking layer 11 and a pressure-sensitive adhesive layer 13 which are provided in this order on one side of the first transparent resin film 10.

A material of the first transparent resin film 10 is, but not limited to, various types of plastic material having transparency. Examples of the material for the first transparent resin film 10 include polyester resins such as polyethylene terephthalate or polybutylene terephthalate, acetate resins, polyethersulfone resins, polycarbonate resins, polyamide resins, polyimide resins, polyolefin resins, (meth)acrylic resins, polyvinyl chloride resins, polyvinylidene chloride resins, polystyrene resins, polyvinyl alcohol resins, polyarylate resins, and polyphenylene sulfide resins. Above all, polyester resins polycarbonate resins polyolefin resins, and polyethersulfone are preferred.

Examples thereof also include, as disclosed in JP-A No. 2001-343529 (WO10/37007), a resin composition that contains a thermoplastic resin having a substituted and/or unsubstituted imide group in the side chain and a thermoplastic resin having a substituted and/or unsubstituted phenyl and nitrile groups in the side chain. Specifically, a resin composition containing an alternating copolymer of isobutylene and N-methylmaleimide and an acrylonitrile-styrene copolymer may be used as the materials of the resin films.

The first transparent resin film 10 used may be a film stretched in at least one direction. The stretching process may be any of various stretching processes such as uniaxial stretching, simultaneous biaxial stretching, and sequential biaxial stretching. In view of mechanical strength, the first transparent resin film 10 is preferably a biaxially stretched resin film.

The first transparent resin film 10 is generally formed of a monolayer film. In general, the first transparent resin film 10 preferably has a thickness of 90 to 300 μm, more preferably 100 to 250 μm.

The oligomer blocking layer 11 is a cured layer formed by curing a composition containing a curable compound and inorganic oxide particles. The oligomer blocking layer 11 has functions such as preventing migration of migrant components in the first transparent resin film 10, typically, migration of low-molecular-weight polyester oligomer components, which are migrant components in a polyester film.

The oligomer blocking layer 11 preferably has a thickness of 120 nm or more so that a sufficient level of scratch resistance and an oligomer migration function can be imparted to the oligomer blocking layer 11. The thickness of the oligomer blocking layer 11 is preferably 150 nm or more, more preferably 300 nm. In general, the oligomer blocking layer-carrying resin film (including the first transparent resin film 10 and the oligomer blocking layer 11 and any functional layer 12 provided on the resin film 10) should be prevented from curling or reduced in cost. Form this point of view, the thickness of the oligomer blocking layer 11 is preferably, but not limited to, 1 μm or less, more preferably 500 nm or less. In addition, since the oligomer blocking layer 11 is the cured layer in the invention, interference fringes can be prevented even when the oligomer blocking layer 11 has a thickness of less than 1 μm, specifically 800 nm or less, more specifically 600 nm or less, in contrast to a conventional oligomer blocking layer with which interference fringes can significantly occur when its thickness is less than 1 μm, and the cured layer can also provide scratch resistance and an oligomer migration preventing function.

The curable compound may be a material that has a functional group containing at least one polymerizable double bond in the molecule and is capable of forming a resin layer. The polymerizable double bond-containing functional group may be a vinyl group, a (meth)acryloyl group, or the like. The term “(meth)acryloyl group” means an acryloyl group and/or a methacryloyl group, and “(meth)”, as used herein, has the same meaning.

The curable compound may be a curable resin having the polymerizable double bond-containing functional group. Examples of such a resin include a silicone resin, a polyester resin, a polyether resin, an epoxy resin, a urethane resin, an alkyd resin, a spiroacetal resin, a polybutadiene resin, a polythiolpolyene resin, an oligomer or prepolymer of an acrylate or methacrylate of a polyfunctional compound such as a polyhydric alcohol. These compounds may be used alone or in combination of two or more.

Besides the above active energy ray-curable resin, the curable compound may be a reactive diluent having a functional group containing at least one polymerizable double bond in the molecule. Examples of the reactive diluent include monofunctional (meth)acrylates such as (meth)acrylates of ethylene oxide-modified phenols, (meth)acrylates of propylene oxide-modified phenols, (meth)acrylates of ethylene oxide-modified nonylphenols, (meth)acrylates of propylene oxide-modified nonylphenols, 2-ethylhexylcarbitol(meth)acrylate, isobornyl(meth)acrylate, tetrahydrofurfuryl(meth)acrylate, hydroxyethyl(meth)acrylate, hydroxypropyl(meth)acrylate, hydroxybutyl(meth)acrylate, hydroxyhexyl(meth)acrylate, diethylene glycol mono(meth)acrylate, triethylene glycol mono(meth)acrylate, and tripropylene glycol mono(meth)acrylate. Examples of the reactive diluent also include bifunctional, trifunctional, and polyfunctional (meth)acrylates such as diethylene glycol di(meth)acrylate, triethylene glycol di(meth)acrylate, dipropylene glycol di(meth)acrylate, tripropylene glycol di(meth)acrylate, tetrapropylene glycol di(meth)acrylate, polypropylene glycol di(meth)acrylate, 1, 4-butanediol di(meth)acrylate, neopentyl glycol di(meth)acrylate, 1,6-hexanediol di(meth)acrylate, di(meth)acrylate of ethylene oxide-modified neopentyl glycol, di(meth)acrylate of ethylene oxide-modified bisphenol A, di(meth)acrylate of propylene oxide-modified bisphenol A, di(meth)acrylate of ethylene oxide-modified hydrogenated bisphenol A, trimethylolpropane di(meth)acrylate, trimethylolpropane allyl ether di(meth)acrylate, trimethylolpropane tri(meth)acrylate, ethylene oxide-modified trimethylolpropane tri(meth)acrylate, propylene oxide-modified trimethylolpropane tri(meth)acrylate, pentaerythritol tetra(meth)acrylate, dipentaerythritol tetra(meth)acrylate, and dipentaerythritol hexa(meth)acrylate. Other examples include butanediol glycerine ether di(meth)acrylate and (meth)acrylate of isocyanuric acid. The reactive diluents may be used alone or in combination of two or more.

The composition used to form the oligomer blocking layer 11 also contains inorganic oxide particles in addition to the curable compound. Examples of the inorganic oxide particles include fine particles of silicon oxide (silica), titanium oxide, aluminum oxide, zinc oxide, tin oxide, zirconium oxide, mica, etc. Particularly preferred are fine particles of silicon oxide (silica), titanium oxide, aluminum oxide, zinc oxide, tin oxide, and zirconium oxide. These may be used alone or in combination of two or more.

The inorganic oxide particles are preferably nanoparticles with a weight average particle size in the range of 1 nm to 200 nm. The weight average particle size is more preferably in the range of 1 nm to 100 nm. The weight average particle size of the inorganic oxide particles is that of fine particles determined by Coulter counting method. More specifically, a particle size distribution meter (Coulter Multisizer (trade name) manufactured by Beckman Coulter, Inc.) based on pore electric resistance method is used to measure the electric resistance of an electrolytic solution, which corresponds to the volume of fine particles passing through pores, so that the number and volume of the fine particles are determined, and the weight average particle size is calculated from the number and volume of the fine particles.

The inorganic oxide particles used may be bonded to an organic compound containing a polymerizable unsaturated group. The polymerizable unsaturated group is cured by reacting with the curable compound to increase the hardness of the oligomer blocking layer. For example, the polymerizable unsaturated group is preferably an acryloyl group, a methacryloyl group, a vinyl group, a propenyl group, a butadienyl group, a styryl group, an ethynyl group, a cinnamoyl group, a maleate group, or an acrylamide group. The polymerizable unsaturated group-containing organic compound is preferably a compound having a silanol group in the molecule or a compound capable of undergoing hydrolysis to produce a silanol group. The polymerizable unsaturated group-containing organic compound also preferably has a photosensitive group.

The refractive index of the oligomer blocking layer (cured layer) 11 is controlled by the addition of the inorganic oxide particles to the curable compound. The refractive index of the oligomer blocking layer 11 is controlled to have a difference of 0.04 or less from the refractive index of the pressure-sensitive adhesive layer 13. The control of the refractive index difference successfully suppresses interference fringes caused by the oligomer blocking layer. The refractive index difference is preferably 0.03 or less, more preferably 0.02 or less.

The content of the inorganic oxide particles is such that the refractive index difference is 0.04 or less when the organic oxide particles are used in combination with the curable compound as described above. The refractive index of the pressure-sensitive adhesive layer 13 is generally from 1.46 to 1.49 (for example, an acrylic pressure-sensitive adhesive layer has a refractive index of about 1.47). Taking into account the refractive indices of the curable compound and the inorganic oxide particles, the content of the organic oxide particles is so determined that the difference between the refractive indices of the oligomer blocking layer 11 and the pressure-sensitive adhesive layer 13 can be 0.04 or less. From these points of view, the content of the inorganic oxide particles (for example, with a refractive index of 1.43 to 1.47) may be in the range of 50 to 300 parts by weight, preferably in the range of 100 to 200 parts by weight, more preferably in the range of 100 to 150 parts by weight, based on 100 parts by weight of the curable compound (for example, with a refractive index of 1.51 to 1.55). Such a content is also preferred in order to impart hardness to the oligomer blocking layer 11 so that curling can be suppressed or in order to impart scratch resistance to the oligomer blocking layer 11.

Besides the curable compound and the inorganic oxide particles, the composition used to form the oligomer blocking layer 11 may also contain second particles with an average particle size of 300 nm to 2 μm other than the inorganic oxide particles. When the second particles are added to the oligomer blocking layer 11, the oligomer blocking layer 11 can have anti-blocking properties. For example, when the oligomer blocking layer 11 contains the second particles, a long resin film having the oligomer blocking layer (a product including the first transparent resin film 10, the oligomer blocking layer 11, and any functional layer 12) can be wound into a roll without using any protective film. If the second particles have an average particle size of less than 300 nm, anti-blocking properties may be insufficient. On the other hand, if the average particle size is more than 2 μm, haze may undesirably increase. The average particle size of the second particles is preferably from 400 to 1,500 nm, more preferably from 500 to 1,000 nm. The average particle size of the second particles is the value determined by laser method.

The content of the second particles is preferably from 0.01 to 10 parts by weight based on 100 parts by weight of the curable compound. If the content of the second particles is less than 0.1 parts by weight, anti-blocking properties may be insufficient. On the other hand, if the content is more than 10 parts by weight, haze may undesirably increase. The content of the second particles is preferably from 0.03 to 5 parts by weight, more preferably from 0.05 to 1 part by weight.

Examples of the second particles include, but are not limited to, crosslinked or non-crosslinked organic particles of various polymers such as poly(methyl methacrylate), polyurethane, polystyrene, acryl-styrene copolymers, and melamine resin; and inorganic particles of glass, silica, alumina, calcium oxide, titania, zirconia, and zinc oxide. The second particles used are other than the inorganic oxide particles. The second particles can be differentiated in average particle size from the inorganic oxide particles, and materials for the second particles may include inorganic oxides. Since any refractive index difference influences the haze, organic particles are preferably used as the second particles. In addition, the second particles used preferably have a refractive index difference of 0.1 or less from the average of the refractive indices of the curable compound and the inorganic oxide particles. When the refractive index difference is 0.1 or less, the increase in haze caused by the addition of the second particles can be kept small. The refractive index difference is more preferably 0.05 or less, even more preferably 0.03 or less. The average of the refractive indices of the curable compound and the inorganic oxide particles corresponds to the refractive index of the oligomer blocking layer produced with these materials.

The oligomer blocking layer 11 is formed as a cured layer, which is produced by curing the composition containing the curable compound and the inorganic oxide particles. The cured layer can be formed by curing with active energy rays or by thermosetting. A polymerization initiator may be added to the composition, depending on the curing method. When electron beams are used as the active energy rays, the polymerization initiator is not particularly necessary. When ultraviolet rays are used as the active energy rays, a photopolymerization initiator should be used. When a thermosetting pressure-sensitive adhesive composition is used, a thermally-cleavable polymerization initiator should be used. The cured layer is preferably formed using ultraviolet rays as the active energy rays.

Examples of the photopolymerization initiator include benzophenone compounds such as benzil, benzophenone, benzoylbenzoic acid, and 3,3′-dimethyl-4-methoxybenzophenone; aromatic ketone compounds such as 4-(2-hydroxyethoxy)phenyl(2-hydroxy-2-propyl)ketone, α-hydroxy-α,α′-dimethylacetophenone, 2-methyl-2-hydroxypropiophenone, and α-hydroxycyclohexyl phenyl ketone; acetophenone compounds such as methoxyacetophenone, 2,2-dimethoxy-2-phenylacetophenone, 2,2-diethoxyacetophenone, and 2-methyl-1-[4-(methylthio)-phenyl]-2-morpholinopropane-1; benzoin ether compounds such as benzoin methyl ether, benzoin ethyl ether, benzoin isopropyl ether, benzoin butyl ether, and anisoin methyl ether; aromatic ketal compounds such as benzyl dimethyl ketal; aromatic sulfonyl chloride compounds such as 2-naphthalenesulfonyl chloride; optically active oxime compounds such as 1-phenone-1,1-propanedione-2-(o-ethoxycarbonyl)oxime; thioxanthone compounds such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone; camphorquinone; halogenated ketones; acylphosphine oxide; acylphosphonate; and 2-hydroxy-1-{4-[4-(2-hydroxy-methyl-propionyl)benzyl]phenyl}-2-methyl-propane-1-one, and 2-methyl-1-(4-methylthiophenyl)-2-morpholinopropane-1-one.

The amount of the photopolymerization initiator is preferably, but not limited to, 0.1 to 10 parts by weight based on 100 parts by weight of the active energy ray-curable compound. The amount of the photopolymerization initiator is preferably 1 part by weight or more, more preferably 2 parts by weight or more. On the other hand, the amount of the photopolymerization initiator is preferably 8 parts by weight or less, more preferably 5 parts by weight or less.

The composition may also be diluted with an appropriate solvent to form a solution of the composition. The solution containing the composition and the solvent is applied to the first transparent resin film 10 to form a coating layer, and then the coating layer is cured after the solvent is removed by drying.

A solvent capable of dissolving the curable compound and so on are selected and used to form the solution of the composition. Examples of solvents that may be used include various solvents such as ether solvents such as dibutyl ether, dimethoxymethane, dimethoxyethane, diethoxyethane, propylene oxide, 1,4-dioxane, 1,3-dioxolane, 1,3,5-trioxane, and tetrahydrofuran; ketone solvents such as acetone, methyl ethyl ketone, methyl isobutyl ketone, diethyl ketone, dipropyl ketone, diisobutyl ketone, cyclopentanone, cyclohexanone, methyl cyclohexanone, 2-octanone, 2-pentanone, 2-hexanone, 2-heptanone, and 3-heptanone; ester solvents such as ethyl formate, propyl formate, n-pentyl formate, methyl acetate, ethyl acetate, butyl acetate, n-pentyl acetate, methyl propionate, and ethyl propionate; acetylacetone solvents such as acetylacetone, diacetone alcohol, methyl acetoacetate, and ethyl acetoacetate; alcohol solvents such as methanol, ethanol, 1-propanol, 2-propanol, 1-butanol, 2-butanol, 1-pentanol, 2-methyl-2-butanol, and cyclohexanol; and glycol ether solvents such as ethylene glycol monoethyl ether acetate, ethylene glycol monoethyl ether, ethylene glycol monobutyl ether, ethylene glycol monomethyl ether, propylene glycol monomethyl ether acetate, and propylene glycol monomethyl ether. These solvents may be used alone or in combination of two or more. The concentration of the solution of the composition is generally from 1 to 60% by weight, preferably from 2 to 10% by weight.

The solution of the composition may be applied by a coating method such as roll coating such as reverse coating or gravure coating, spin coating, screen coating, fountain coating, dipping, or spraying. The coating layer is formed so that an oligomer blocking layer 11 with a thickness of 120 nm or more can be finally obtained.

Subsequently, the solvent in the coating layer is removed by drying, and then the coating layer is cured. Curing means may be selected from thermosetting or curing with active energy rays. In general, ultraviolet irradiation is preferably performed as the curing means. Ultraviolet irradiation can be performed using a high-pressure mercury lamp, a low-pressure mercury lamp, a halogen lamp, a xenon lamp, a metal halide lamp, or the like. Ultraviolet irradiation is preferably performed at an ultraviolet wavelength of 365 nm and a total dose of 50 to 500 mJ/cm². When the dose is 50 mJ/cm or more, curing can be performed more sufficiently, so that the resulting oligomer blocking layer 11 can have a more sufficient level of hardness. When the dose is 500 mJ/cm² or less, discoloration of the resulting oligomer blocking layer 11 can be prevented.

The resin film with pressure-sensitive adhesive layer 1 may further include a functional layer 12 on the side of the first transparent resin film 10 opposite to the first transparent resin film 10 side where the oligomer blocking layer 11 is provided. As described above, the oligomer blocking layer 11 may be provided as an outermost layer on one side of the first transparent resin film 10, and the functional layer 12 may be provided as another outermost layer on the other side of the first transparent resin film 10.

For example, a hard coating layer may be provided as the functional layer 12 (the functional layer other than the oligomer blocking layer) to protect the outer surface. A cured film derived from curable resin such as melamine resin, urethane resin, alkyd resin, acrylic resin, or silicone resin is preferably used as a material to form the hard coating layer. The hard coating layer preferably has a thickness of 0.1 to 30 μm. Setting the thickness at 0.1 μm or more is preferred to provide hardness. If the thickness is more than 30 μm, the hard coating layer may be cracked, or curling may occur across the resin film with pressure-sensitive adhesive layer 1(B).

An anti-glare layer or an anti-reflection layer may also be provided as the functional layer 12 to improve visibility. An anti-glare layer or an anti-reflection layer may be provided on the hard coating layer. The material used to form the anti-glare layer is typically, but not limited to, ionizing radiation-curable resin, thermosetting resin, thermoplastic resin, or the like. The anti-glare layer preferably has a thickness of 0.1 to 30 μm. The anti-reflection layer may be formed using titanium oxide, zirconium oxide, silicon oxide, magnesium fluoride, or the like. A plurality of anti-reflection layers may be provided.

Any transparent pressure-sensitive adhesive may be used for the pressure-sensitive adhesive layer 13 without limitation. For example, the pressure-sensitive adhesive may be appropriately selected from adhesives based on polymers such as acrylic polymers, silicone polymers, polyester, polyurethane, polyamide, polyvinyl ether, vinyl acetate-vinyl chloride copolymers, modified polyolefins, epoxy polymers, fluoropolymers, and rubbers such as natural rubbers and synthetic rubbers. In particular, acrylic pressure-sensitive adhesives are preferably used, because they have good optical transparency and good weather or heat resistance and exhibit suitable wettability and adhesion properties such as cohesiveness and adhesiveness.

The pressure-sensitive adhesive layer 13 may contain a crosslinking agent depending on the base polymer. If necessary, the pressure-sensitive adhesive layer 13 may also contain appropriate additives such as natural or synthetic resins, glass fibers or beads, or fillers comprising metal powder or any other inorganic powder, pigments, colorants, and antioxidants. The pressure-sensitive adhesive layer 13 may also contain transparent fine particles so as to have light diffusing ability.

The transparent fine particles to be used may be one or more types of appropriate conductive inorganic fine particles of silica, calcium oxide, alumina, titania, zirconia, tin oxide, indium oxide, cadmium oxide, antimony oxide, or the like with an average particle size of 0.5 to 20 μm or one or more types of appropriate crosslinked or uncrosslinked organic fine particles of an appropriate polymer such as poly (methyl methacrylate) and polyurethane with an average particle size of 0.5 to 20 μm.

The pressure-sensitive adhesive layer 13 is generally formed using a pressure-sensitive adhesive solution (with a solids content of about 10 to about 50% by weight), in which a base polymer or a composition thereof is dissolved or dispersed in a solvent. An organic solvent such as toluene and ethyl acetate, water, or any other solvent may be appropriately selected depending on the type of the pressure-sensitive adhesive and used as the above solvent.

The pressure-sensitive adhesive layer 13 may be formed by placing it on the oligomer blocking layer 11. Examples of the method of forming it include, but are not limited to, a method including applying a pressure-sensitive adhesive (solution) and drying it, and a method including providing a pressure-sensitive adhesive layer on a release film and transferring it from the release film. The method of application may be roll coating such as reverse coating or gravure coating, spin coating, screen coating, fountain coating, dipping, or spraying.

The laminated film 2 is obtained after the resin film with pressure-sensitive adhesive layer 1 is bonded to the second transparent resin film 20 (including the case of a transparent conductive film) described below. In the laminated film 2, the pressure-sensitive adhesive layer 13 has a cushion effect and thus can function to improve the scratch resistance of a transparent conductive layer 22 provided on one side of the second transparent resin film 20 and to improve the tap properties, specifically, the pen input durability and the contact pressure durability, of a touch panel-forming transparent conductive film. In terms of performing this function better, it is preferred that the elastic modulus of the pressure-sensitive adhesive layer 13 should be set in the range of 1 to 100 N/cm² and that its thickness should be set at 1 μm or more, generally in the range of 5 to 100 μm. With such a thickness, the effect is sufficiently produced, and a satisfactory adhesive strength is provided between the second transparent resin film 20 and the pressure-sensitive adhesive layer 13 of the resin film with pressure-sensitive adhesive layer 1. If the thickness is less than the above range, the durability or the adhesion cannot be ensured sufficiently, and if the thickness is more than the above range, the appearance such as the transparency may be degraded.

If the elastic modulus is less than 1 N/cm², the pressure-sensitive adhesive layer 13 can be inelastic so that the pressure-sensitive adhesive layer 13 can easily deform by pressing to make the second transparent resin film 2 irregular and further to make the transparent conductive layer 22 irregular provided on the transparent conductive film 20. If the elastic modulus is less than 1 N/cm², the pressure-sensitive adhesive can easily squeeze out of the cut section, and the effect of improving the scratch resistance of the transparent conductive layer 22 or improving the tap properties of the transparent conductive layer 22 for touch panels can be reduced. If the elastic modulus is more than 100 N/cm², the pressure-sensitive adhesive layer 13 can be hard, and the cushion effect cannot be expected, so that the scratch resistance of the transparent conductive layer 22 or the pen input durability and surface contact pressure durability of the transparent conductive layer 22 for touch panels can tend to be difficult to improve.

If the thickness of the pressure-sensitive adhesive layer 13 is less than 1 μm, the cushion effect also cannot be expected so that the scratch resistance of the transparent conductive layer 22 or the pen input durability and surface contact pressure durability of the transparent conductive layer 22 for touch panels can tend to be difficult to improve. If it is too thick, it can reduce the transparency, or it can be difficult to obtain good results on the formation of the pressure-sensitive adhesive layer 13, the bonding workability of the pressure-sensitive adhesive layer 13 of the resin film with the pressure-sensitive adhesive layer 1 and the second transparent resin film 20, and the cost.

The laminated film 2(B) bonded through the pressure-sensitive adhesive layer 13 as described above imparts good mechanical strength and contributes to not only the pen input durability and the surface contact pressure durability but also the prevention of curling.

The anchoring strength between the oligomer blocking layer and the pressure-sensitive adhesive layer is 1 N/25 mm or more. The anchoring strength is preferably 4 N/25 mm or more. Setting the anchoring strength at 4 N/25 mm or more makes it possible to suppress the deformation of the pressure-sensitive adhesive layer under pen input pressure, for example, when the resulting laminated film (the transparent conductive laminated film) is used in a touch panel.

The pressure-sensitive adhesive 13 may be protected by a release film until it is subjected to the lamination. In such a case, for example, the release film to be used may be a laminate of a polyester film of a migration-preventing layer and/or a release layer, which is provided on a polyester film side to be bonded to the pressure-sensitive adhesive layer 13.

The total thickness of the release film is preferably 30 μm or more, more preferably in the range of 60 to 100 μm. This is to prevent deformation (dents) of the pressure-sensitive adhesive layer 13 in a case where the pressure-sensitive adhesive layer 13 is formed and then stored in the form of a roll, in which the deformation (dents) would be expected to occur due to foreign particles or the like intruding between portions of the rolled layer.

The migration-preventing layer may be made of an appropriate material for preventing migration of migrant components in the polyester film, particularly for preventing migration of low molecular weight oligomer components in the polyester. An inorganic or organic material or a composite thereof may be used to form the migration-preventing layer. The thickness of the migration-preventing layer may be set in the range of 0.01 to 20 μm as needed. The method of forming the migration-preventing layer, is not particularly limited, but for example, includes coating method, spraying method, spin coating method, or in-line coating method. Further, Vacuum deposition method, sputtering method, ion plating method, spray thermal decomposition method, chemical plating method, electroplating method, or the like may also be used.

The mold release layer may be made of an appropriate release agent such as a silicone-based mold release agent, a long-chain alkyl-based mold release agent, a fluorochemical-based mold release agent, or molybdenum sulfide. The thickness of the release layer may be set as appropriate in view of the release effect. In general, the thickness is preferably 20 μm or less, more preferably in the range of 0.01 to 10 μm, particularly preferably in the range of 0.1 to 5 μm, in view of handleability such as flexibility. The method of forming the release layer is not restricted, and the release layer may be formed using the same method as the method of forming the migration-preventing layer.

An ionizing radiation cured resin such as an acrylic resin, a urethane-based resin, a melamine-based resin, or an epoxy-based resin or a mixture of any of the above resins and aluminum oxide, silicon dioxide, mica, or the like may be used in the coating method, spraying method, spin coating method, or in-line coating method. Further, when the vacuum deposition method, sputtering method, ion plating method, spray thermal decomposition method, chemical plating method, or electroplating method is used, an oxide of a metal such as gold, silver, platinum, palladium, copper, aluminum, nickel, chromium, titanium, iron, cobalt, or tin, an oxide of an alloy thereof, or any other metal compounds such as metal iodides may be used.

The laminated film 2 of the invention can be formed by placing the second transparent resin film 20 on the pressure-sensitive adhesive layer 13 of the resin film with pressure-sensitive adhesive layer 1.

A transparent conductive layer 22 may be provided directly on one side of the second transparent resin film 20 opposite to the other side where the pressure-sensitive adhesive layer 13 is bonded, or provided on the one side of the second transparent resin film 20 with an undercoat layer interposed therebetween.

The anchoring strength can be improved using an appropriate pressure-sensitive adhesive primer, depending on the type of the pressure-sensitive adhesive used to form the pressure-sensitive adhesive layer 13. Thus, when such a pressure-sensitive adhesive is used, a certain pressure-sensitive adhesive primer is preferably used. The pressure-sensitive adhesive primer is generally provided on the second transparent resin film 20 side.

The pressure-sensitive adhesive primer may be of any type capable of increasing the anchoring strength of the pressure-sensitive adhesive. Examples of the pressure-sensitive adhesive primer that may be used include what is called a coupling agent, such as a silane coupling agent having a hydrolyzable alkoxysilyl group and a reactive functional group such as an amino, vinyl, epoxy, mercapto, or chloro group in the same molecule, a titanate coupling agent having an organic functional group and a titanium-containing hydrolyzable hydrophilic group in the same molecule, and an aluminate coupling agent having an organic functional group and an aluminum-containing hydrolyzable hydrophilic group in the same molecule; and a resin having an organic reactive group, such as an epoxy resin, an isocyanate resin, a urethane resin, or an ester urethane resin. In particular, a silane coupling agent-containing layer is preferred, because it is easy to handle industrially.

The second transparent resin film 20 may be of the same type as the first transparent resin film 10. The second transparent resin film 20 may be made of the same material as the first transparent resin film 10. The second transparent resin film 20 generally has a thickness of 10 to 200 μm, preferably 20 to 100 μm.

A transparent conductive layer 22 may be provided directly on one side of the second transparent resin film 20 opposite to the other side where the pressure-sensitive adhesive layer 13 is bonded, or provided on the one side of the second transparent resin film 20 with an undercoat layer interposed therebetween.

When the transparent conductive layer 22 is provided on the second transparent resin film 20 to form a transparent conductive film, the second transparent resin film 20 preferably has a thickness of 10 to 40 μm, more preferably 20 to 30 μm. If the thickness of the second transparent resin film 20 used to form a transparent conductive film is less than 10 μm, the mechanical strength of the second transparent resin film 20 may be insufficient, so that it may be difficult to perform the process of continuously forming the transparent conductive layer 22 on the second transparent resin film 20 being fed from a roll. If the thickness is more than 40 μm, the amount of introduction of the second transparent resin film 20 may decrease in the process of forming the transparent conductive layer 22, and the process of removing gas or moisture may be hindered, so that productivity may decrease. In this case, it may also be difficult to reduce the thickness of the transparent conductive laminated film.

The surface of the second transparent resin film 20 may be previously subject to sputtering, corona discharge treatment, flame treatment, ultraviolet irradiation, electron beam irradiation, chemical treatment, etching treatment such as oxidation, hard coating, or undercoating treatment such that the adhesion of the transparent conductive layer 22 or the undercoat layer 21 formed thereon to the second transparent resin film 20 can be improved. If necessary, the second transparent resin film 20 may also be subjected to dust removing or cleaning by solvent cleaning, ultrasonic cleaning or the like, before the transparent conductive layer 22 or the undercoat layer 21 is formed.

For example, materials that are preferably used to form the transparent conductive layer 22 include, but are not limited to, tin oxide-doped indium oxide, antimony-doped tin oxide, etc. When the above metal oxide is used to form the transparent conductive layer 22, the transparent conductive layer 22 can be made amorphous by controlling the content of tin oxide in the material (by adding tin oxide in a predetermined amount). When an amorphous transparent conductive layer is formed, the metal oxide preferably contains 90 to 99% by weight of indium oxide and 1 to 10% by weight of tin oxide. The metal oxide more preferably contains 95 to 98% by weight of indium oxide and 2 to 5% by weight of tin oxide. After the transparent conductive layer 22 is formed, if necessary, annealing may be performed in the range of 100 to 150° C. for crystallization. Alternatively, the amorphous transparent conductive thin layer may be crystallized by a heat treatment after the laminated film of the invention is formed. The crystallization may be performed using the same heating temperature (100 to 150° C.) as the annealing.

As used herein, the term “amorphous” means that when the surface of the transparent conductive thin layer is observed using a field emission transmission electron microscope (EE-TEM), the ratio of the area occupied by polygonal or elliptical crystals to the whole surface area of the transparent conductive thin layer is 50% or less (preferably 0 to 30%).

The thickness of the transparent conductive layer 22 is preferably, but not limited to, 10 nm or more, in order that it may form a highly-conductive continuous coating film with a surface resistance of 1×10³ Q/square or less. If the thickness is too large, a reduction in transparency and so on may occur. Therefore, the thickness is preferably from 15 to 35 nm, more preferably from 20 to 30 nm. If the thickness is less than 15 nm, the surface electric resistance may be too high, and it may be difficult to form a continuous coating film. If the thickness is more than 35 nm, a reduction in transparency may occur.

The transparent conductive layer 22 may be formed using known conventional methods, while the methods are not particularly limited. Examples of such methods include vacuum deposition, sputtering, and ion plating. Any appropriate method may be used depending on the required film thickness.

The undercoat layer 21 may be made of an inorganic material, an organic material or a mixture of an inorganic material and an organic material. The undercoat layer 21 may be formed of a single layer or two or more layers. When two or more layers are formed, any combination may be used.

Examples of the inorganic material include NaF (1.3), Na AlF₆ (1.35), LiF (1.36), MgF₂ (1.38), CaF₂ (1.4), BaF₂ (1.3), SiO₂ (1.46), LaF₃ (1.55), CeF₃ (1.63), and Al₂O₃ (1.63), wherein each number inside the parentheses is the refractive index of each material. In particular, SiO₂, MgF₂, Al₂O₃, or the like is preferably used. In particular, SiO₂ is preferred. Besides the above, a complex oxide containing about 10 to about 40 parts by weight of cerium oxide and about 0 to about 20 parts by weight of tin oxide based on 100 parts by weight of the indium oxide may also be used.

The undercoat layer made of an inorganic material may be form with a dry process such as vacuum deposition, sputtering or ion plating, a wet process (coating process), or the like. SiO₂ is preferably used as the inorganic material to form the undercoat layer as described above. In a wet process, a silica sol or the like may be applied to form a SiO₂ film.

Examples of the organic material include acrylic resins, urethane resins, melamine resins, alkyd resins, siloxane polymers, and organosilane-based condensates. At least one of these organic materials may be used. In particular, a thermosetting resin including a mixture composed of a melamine resin, an alkyd resin and an organosilane condensate is preferably used as the organic material.

The thickness of the undercoat layer 21 is generally, but not limited to, from about 1 to about 300 nm, preferably from 5 to 300 nm, in view of optical design and the effect of preventing the release of an oligomer from the second transparent resin film 20. When two or more undercoat layers 21 are provided, the thickness of each layer may be from about 5 to about 250 nm, preferably from 10 to 250 nm.

In the process of producing the laminated film 2(B) shown in FIG. 2B, the transparent conductive layer 22 of the laminated film 2(B) may be an amorphous transparent conductive thin layer made of a metal oxide, and in this case, the amorphous transparent conductive thin layer may be crystallized by heating.

### EXAMPLES

Hereinafter, the invention is more specifically described with reference to the examples, which however are not intended to limit the gist of the invention.

### Example 1

### (Formation of Hard Coating Layer)

A toluene solution for use as a hard coating layer-forming material was prepared by adding 5 parts by weight of 1-hydroxy-cyclohexyl-phenyl ketone (Irgacure 184 manufactured by Ciba Specialty Chemicals Inc.) as a photopolymerization initiator to 100 parts by weight of an acrylic urethane resin (UNIDIC 17-806 manufactured by DIC Corporation) and diluting the mixture with toluene to a concentration of 30% by weight.

The hard coating layer-forming material was applied to one side of a 125 μm thick polyethylene terephthalate film as a first transparent resin film and dried at 100° C. for 3 minutes . The coating was then irradiated with ultraviolet light from a high-pressure mercury lamp at a total dose of 300 mJ/cm² to form a 7 μm thick hard coating layer.

### (Preparation of Oligomer Blocking Layer-Forming Material)

Provided was a mixture (OPSTAR Z7540 (trade name) manufactured by JSR Corporation, solids content: 56% by weight, solvent: butyl acetate/methyl ethyl ketone (MEK)=76/24 (volume ratio), refractive index: 1.49) for an oligomer blocking layer-forming material. The mixture for an oligomer blocking layer-forming material contains active energy ray-curable compounds and silica nanoparticles dispersed therein, in which the silica nanoparticles are composed of inorganic oxide particles and a polymerizable unsaturated group-containing organic compound bonded to the inorganic oxide particles. The mixture for an oligomer blocking layer-forming material contains dipentaerythritol and isophorone diisocyanate-based polyurethane as active energy ray-curable compounds, and silica fine particles (at most 100 nm in weight average particle size) whose surface is modified with an organic molecule, in which the weight ratio of the active energy ray-curable compounds to the particles is 2:3. Five parts by weight of a photopolymerization initiator (Irgacure 127 (trade name) manufactured by Ciba Specialty Chemicals Inc.) was added to the mixture for an oligomer blocking layer-forming material based on 100 parts by weight of the active energy ray-curable compounds. The resulting mixture was diluted with methyl ethyl ketone to a solid concentration of 5% by weight, so that an oligomer blocking layer-forming material was obtained.

### (Formation of Oligomer Blocking Layer)

Using a comma coater, the oligomer blocking layer-forming material was applied to the surface of the first transparent resin film opposite to its surface where the hard coating layer was formed, so that a coating layer was formed. The coating layer was then dried by heating at 145° C. for 1 minute. Subsequently, the coating layer was irradiated with ultraviolet light from a high-pressure mercury lamp at a total dose of 300 mJ/cm² to form a 120 nm thick oligomer blocking layer, so that an oligomer blocking layer carrying hard coated film was obtained.

### (Preparation of Pressure-Sensitive Adhesive Layer-Carrying Hard Coated Film)

A pressure-sensitive adhesive layer was formed on the oligomer blocking layer of the oligomer blocking layer-carrying hard-coated film, so that a pressure-sensitive adhesive layer-carrying hard-coated film was obtained. The pressure-sensitive adhesive layer formed was a 25 μm thick transparent acrylic pressure-sensitive adhesive layer (1.47 in refractive index) with an elastic modulus of 10 N/cm². The composition used to form the pressure-sensitive adhesive layer was a mixture containing 100 parts by weight of an acryl-based copolymer of butyl acrylate, acrylic acid, and vinyl acetate (100:2:5 in weight ratio) and 1 part by weight of an isocyanate crosslinking agent.

### (Preparation of Transparent Conductive Film)

In a 0.4 Pa atmosphere composed of 80% argon gas and 20% oxygen gas, a 22 nm thick ITO layer was formed on one surface of a 25 μm thick polyethylene terephthalate film as a second transparent resin film by a reactive sputtering method using a sintered material of 97% by weight of indium oxide and 3% by weight of tin oxide under the conditions of a polyethylene terephthalate film temperature of 100° C. and a discharge power of 6.35 W/cm², so that a transparent conductive film was obtained. The ITO layer was amorphous.

### (Preparation of Transparent Conductive Laminated Film)

The pressure-sensitive adhesive layer of the pressure-sensitive adhesive layer-carrying hard-coated film was bonded to the surface of the transparent conductive film opposite to its surface where the transparent conductive layer was not formed, so that a transparent conductive laminated film was obtained. The resulting transparent conductive laminated film was heat-treated at 140° C. for 90 minutes so that the amorphous ITO layer was crystallized.

### Examples 2 to 6 and Comparative Example 1

Oligomer blocking layer-carrying hard-coated films were obtained as in Example 1, except that in the process of forming the oligomer blocking layer, the thickness of the oligomer blocking layer was changed as shown in Table 1. Pressure-sensitive adhesive layer-carrying hard-coated films were prepared using the hard-coated films, respectively, as in Example 1, and transparent conductive laminated films were obtained using the pressure-sensitive adhesive layer-carrying hard-coated films, respectively, as in Example 1.

### Example 7

### (Preparation of Oligomer Blocking Layer-Forming Material)

Crosslinked acryl-styrene copolymer particles (XX-160AA (trade name) manufactured by SEKISUI CHEMICAL CO., LTD., average particle size: 0.8 μm, refractive index: 1.49) were further added in an amount of 0.1 parts by weight to the oligomer blocking layer-forming material prepared in Example 1 based on 100 parts by weight of the solid of the active energy ray-curable compounds in the oligomer blocking layer-forming material. The resulting mixture was diluted with methyl ethyl ketone to a solid concentration of 7% by weight, so that an oligomer blocking layer-forming material was obtained.

An oligomer blocking layer-carrying hard-coated film was obtained as in Example 1, except that the oligomer blocking layer-forming material prepared as described above was used in the process of forming the oligomer blocking layer and that the thickness of the oligomer blocking layer was changed as shown in Table 1. A pressure-sensitive adhesive layer-carrying hard-coated film was prepared using the hard-coated film as in Example 1, and a transparent conductive laminated film was obtained using the pressure-sensitive adhesive layer-carrying hard-coated film as in Example 1.

### Comparative Example 2

A hard-coated film was obtained as in Example 1, except that the oligomer blocking layer was formed by a process including applying a siloxane oligomer solution (COLCOAT N103X manufactured by COLCOAT CO. , LTD., refractive index: 1.45) as an oligomer blocking layer-forming material to form a coating layer and then heating the coating at 145° C. for 1 minute to form an oligomer blocking layer and that the thickness of the oligomer blocking layer was changed to 100 nm. A pressure-sensitive adhesive layer-carrying hard-coated film was prepared using the hard-coated film as in Example 1, and a transparent conductive laminated film was obtained using the pressure-sensitive adhesive layer-carrying hard-coated film as in Example 1.

### Comparative Example 3

A hard-coated film was obtained as in Example 1, except that the oligomer blocking layer-forming material used to form the oligomer blocking layer was a toluene solution prepared by adding 5 parts by weight of a photopolymerization initiator (Irgacure 127 (trade name) manufactured by Ciba Specialty Chemicals Inc.) to 100 parts by weight of an acrylic urethane resin (UNIDIC 17-806 manufactured by DIC Corporation, refractive index: 1.53) and diluting the mixture with toluene to a concentration of 5% by weight and that the thickness of the oligomer blocking layer was changed to 200 nm. A pressure-sensitive adhesive layer-carrying hard-coated film was prepared using the hard-coated film as in Example 1, and a transparent conductive laminated film was obtained using the pressure-sensitive adhesive layer-carrying hard-coated film as in Example 1.

### Comparative Example 4

A hard-coated film was obtained as in Example 1, except that the oligomer blocking layer-forming material used to form the oligomer blocking layer was a toluene solution prepared by adding 5 parts by weight of a photopolymerization initiator (Irgacure 127 (trade name) manufactured by Ciba Specialty Chemicals Inc.) to 100 parts by weight of an acrylic urethane resin (UNIDIC 17-806 manufactured by DIC Corporation, refractive index: 1.53) and diluting the mixture with toluene to a concentration of 5% by weight and that the thickness of the oligomer blocking layer was changed to 1000 nm. A pressure-sensitive adhesive layer-carrying hard-coated film was prepared using the hard-coated film as in Example 1, and a transparent conductive laminated film was obtained using the pressure-sensitive adhesive layer-carrying hard-coated film as in Example 1.

The oligomer blocking layer-carrying hard-coated film and the pressure-sensitive adhesive layer-carrying hard-coated film obtained in each of the examples and the comparative examples were evaluated as described below. The results are shown in Table 1.

### <Measurement of Refractive Index>

The refractive index of the oligomer blocking layer and the pressure-sensitive adhesive layer was measured using a refractometer (DR-M2/1550 (trade name)). Monobromonaphthalene was selected as the intermediate liquid, and the measurement light was incident on the surface of the oligomer blocking layer and the pressure-sensitive adhesive layer being measured, when the measurement method described in the instructions for the instrument was performed. The refractive index of the second particles was measured as follows. The particles were placed on a slide glass. A refractive index standard liquid was dropped on the particles, and a cover glass was placed over the particles, so that a sample was obtained. The prepared sample was observed with a microscope, and the refractive index of the second particles was defined as the refractive index of a refractive index standard liquid with which the contour of the particles became most difficult to identify at the interface with the refractive index standard liquid. The average of the refractive indices of the curable compounds and the inorganic oxide particles corresponds to the refractive index of the oligomer blocking layer not containing the second particles.

<Anchoring Strength between Oligomer Blocking Layer and Pressure-Sensitive Adhesive Layer>

Provided was a polyethylene terephthalate film (125 Tetolight OES manufactured by OIKE & Co., Ltd.) whose one side was coated with indium tin oxide by vapor deposition. The pressure-sensitive adhesive layer of a 25 mm wide cut piece of the pressure-sensitive adhesive layer-carrying hard-coated film was press-bonded to the surface of the polyethylene terephthalate film opposite to the indium tin oxide-coated surface by using a 2 kg roller reciprocating once on the cut piece, so that a sample was obtained. Subsequently, after the sample was aged at 23° C. for 1 hour, the polyethylene terephthalate film was peeled off together with the pressure-sensitive adhesive layer in a 180° direction at a rate of 300 mm/minute, when the adhesive strength (N/25 mm) was measured.

### <Oligomer Blocking Properties>

The pressure-sensitive adhesive layer-carrying hard-coated film was stored in a 150° C. environment for 1 hour. The haze of the pressure-sensitive adhesive layer-carrying hard-coated film was measured before and after the storage. The difference (ΔH) between the measured hazes was calculated and evaluated according to the criteria below. The haze was measured according to JIS K-7136 in a 25° C. atmosphere using HAZE METER HM-150 manufactured by Murakami Color Research Laboratory.

◯: ΔH≦0.3

Δ: 0.3<ΔH≦1.0

×: 1.0<ΔH

### <Durability (Adhesion Against Moisture)>

The pressure-sensitive adhesive layer of the pressure-sensitive adhesive layer-carrying hard-coated film was bonded to a glass plate and stored in a humid environment at 40° C. and 92% R.H. for 120 hours. Subsequently, after the glass plate was transferred to and allowed to stand under room temperature conditions (23° C. and 55% R.H.), the pressure-sensitive adhesive layer-carrying hard-coated film was subjected to the cross-cut peel test according to JIS K 5400 and evaluated according to the criteria below.

◯: No peeling occurs inside or outside the lattice.

×: Peeling occurs either inside or outside the lattice.

### <Interference Fringes Caused by Oligomer Blocking Layer>

The pressure-sensitive adhesive layer of the pressure-sensitive adhesive layer-carrying hard-coated film was bonded to a black acrylic plate. In a dark room, oligomer blocking layer-induced interference fringes were visually observed under a three-wavelength fluorescent tube, and evaluated according to the criteria below.

◯: There are no oligomer blocking layer-induced interference fringes affecting the appearance.

×: There are oligomer blocking layer-induced interference fringes affecting the appearance.

### <Scratch Resistance of the Surface of Oligomer Blocking Layer>

The surface of the oligomer blocking layer of the oligomer blocking layer-carrying hard-coated film was rubbed 10 times over a length of 10 cm with steel wool under a load of 250 g/25 mmφ. The surface state of the oligomer blocking layer was then visually observed and evaluated according to the criteria below.

◯: No scratch is observed.

Δ: Thin scratches are observed over the surface.

×: Significant scratches are observed over the surface.

### <Anti-Blocking Properties>

Two rectangular sample pieces of 5 cm×15 cm were prepared by cutting the oligomer blocking layer-carrying hard-coated film. The two sample pieces were then sandwiched between two glass plates. In this process, the two sample pieces were arranged in such a manner the oligomer blocking layer and the hard coating layer faced each other. The resulting laminate was stored under a pressure of 30 g/cm² for 24 hours. Subsequently, the ratio of the bonded area to the whole area of the sample was visually observed and evaluated according to the criteria below.

◯: The bonded area is at most 5% of the whole area of the hard coating layer formed on the transparent resin film.

×: The bonded area is more than 5% of the whole area of the hard coating layer formed on the transparent resin film.

TABLE 1

| | | | | | | Difference | | | | | | |
|---|---|---|---|---|---|---|---|---|---|---|---|---|
| | | | | | | in | Anchoring | | | | | |
| | | | | | | refractive | Strength | | | | | |
| | | | | | | index | between | | | | | |
| | | | | | | between | Oligomer | | | | | |
| | | | | | | Oligomer | Blocking | | | | | |
| | | | | | | Blocking | Layer and | Evaluation | | | | |
| | | | | | | Layer and | Pressure- | Olig- | Adhe- | | Scratch | Anti- |
| | Oligomer blocking layer | | | Pressure-sensitive | | Pressure- | Sensitive | omer | sion | Inter- | resistance | block- |
| | | Re- | Thick- | adhesive layer | | Sensitive | Adhesive | blocking | against | fer- | of oligomer | ing |
| | | fractive | ness | Refractive | Thickness | Adhesive | Layer | prop- | mois- | ence | blocking | proper- |
| | Materials | index | (nm) | index | (μm) | Layer | (N/25 mm) | erties | ture | fringes | layer | ties |
| Exam- | Active energy ray- | 1.49 | 120 | 1.47 | 25 | 0.02 | 10.5 | Δ | ∘ | ∘ | Δ | x |
| ple 1 | curable compounds | | | | | | | | | | | |
| | and inorganic | | | | | | | | | | | |
| | fine particles | | | | | | | | | | | |
| Exam- | Active energy ray- | 1.49 | 150 | 1.47 | 25 | 0.02 | 11 | ∘ | ∘ | ∘ | Δ | x |
| ple 2 | curable compounds | | | | | | | | | | | |
| | and inorganic | | | | | | | | | | | |
| | fine particles | | | | | | | | | | | |
| Exam- | Active energy ray- | 1.49 | 200 | 1.47 | 25 | 0.02 | 11 | ∘ | ∘ | ∘ | Δ | x |
| ple 3 | curable compounds | | | | | | | | | | | |
| | and inorganic | | | | | | | | | | | |
| | fine particles | | | | | | | | | | | |
| Exam- | Active energy ray- | 1.49 | 300 | 1.47 | 25 | 0.02 | 11.5 | ∘ | ∘ | ∘ | ∘ | x |
| ple 4 | curable compounds | | | | | | | | | | | |
| | and inorganic | | | | | | | | | | | |
| | fine particles | | | | | | | | | | | |
| Exam- | Active energy ray- | 1.49 | 500 | 1.47 | 25 | 0.02 | 11 | ∘ | ∘ | ∘ | ∘ | x |
| ple 5 | curable compounds | | | | | | | | | | | |
| | and inorganic | | | | | | | | | | | |
| | fine particles | | | | | | | | | | | |
| Exam- | Active energy ray- | 1.49 | 1000 | 1.47 | 25 | 0.02 | 12 | ∘ | ∘ | ∘ | ∘ | x |
| ple 6 | curable compounds | | | | | | | | | | | |
| | and inorganic | | | | | | | | | | | |
| | fine particles | | | | | | | | | | | |
| Exam- | Active energy ray- | 1.49 | 300 | 1.47 | 25 | 0.02 | 11 | ∘ | ∘ | ∘ | ∘ | ∘ |
| ple 7 | curable compounds | | | | | | | | | | | |
| | and inorganic | | | | | | | | | | | |
| | fine particles + | | | | | | | | | | | |
| | Second particles | | | | | | | | | | | |
| Compar- | Active energy ray- | 1.49 | 100 | 1.47 | 25 | 0.02 | 11 | x | ∘ | ∘ | x | x |
| ative | curable compounds | | | | | | | | | | | |
| Exam- | and inorganic | | | | | | | | | | | |
| ple 1 | fine particles | | | | | | | | | | | |
| Compar- | Inorganic | 1.45 | 100 | 1.47 | 25 | 0.02 | 9 | ∘ | x | ∘ | x | x |
| ative | curable | | | | | | | | | | | |
| Exam- | compound | | | | | | | | | | | |
| ple 2 | | | | | | | | | | | | |
| Compar- | Active energy | 1.53 | 200 | 1.47 | 25 | 0.06 | 10.5 | ∘ | ∘ | x | Δ | x |
| ative | ray- | | | | | | | | | | | |
| Exam- | curable | | | | | | | | | | | |
| ple 3 | compounds | | | | | | | | | | | |
| Compar- | Active energy | 1.53 | 1000 | 1.47 | 25 | 0.06 | 11 | ∘ | ∘ | x | ∘ | x |
| ative | ray- | | | | | | | | | | | |
| Exam- | curable | | | | | | | | | | | |
| ple 4 | compounds | | | | | | | | | | | |

Table 1 shows that the oligomer blocking layer of the pressure-sensitive adhesive layer-carrying hard-coated film in each of the examples satisfies the requirements including oligomer blocking properties, scratch resistance, and adhesion and is prevented from causing interference fringes even when made thin, because the oligomer blocking layer is a cured layer produced by curing a composition containing an active energy ray-curable compound and inorganic oxide particles and because the difference in refractive index between the oligomer blocking layer and the pressure-sensitive adhesive layer is controlled to be at most 0.04. In contrast, the oligomer blocking layer in Comparative Example 1 is too thin to provide a satisfactory level of oligomer blocking properties or scratch resistance. The oligomer blocking layer in Comparative Example 2 does not provide a satisfactory level of adhesion against moisture, prevention of interference fringes, or scratch resistance, because the oligomer blocking layer is made from an inorganic curable compound and is too thin although the difference in refractive index between the oligomer blocking layer and the pressure-sensitive adhesive layer is controlled to be at most 0.04. The oligomer blocking layer in each of Comparative Examples 3 and 4 is not prevented from causing interference fringes because the difference in refractive index between the oligomer blocking layer and the pressure-sensitive adhesive layer is not controlled to be at most 0.04.

### DESCRIPTION OF REFERENCE SIGNS

1 Resin film with pressure-sensitive adhesive layer

10 First transparent resin film

11 Oligomer blocking layer

12 Functional layer (hard coating layer)

13 Pressure-sensitive adhesive layer

2 Laminated film

20 Second transparent resin film

21 Undercoat layer

22 Transparent conductive layer

1. A resin film with pressure-sensitive adhesive layer, comprising a first transparent resin film, an oligomer blocking layer, and a pressure-sensitive adhesive layer laminated in this order,
wherein the oligomer blocking layer is a cured layer formed by curing a composition containing a curable compound and inorganic oxide particles,
the oligomer blocking layer has a thickness of 120 nm or more,
the oligomer blocking layer has a refractive index difference of 0.04 or less from the pressure-sensitive adhesive layer, and
an anchoring strength between the oligomer blocking layer and the pressure-sensitive adhesive layer is 1 N/25 mm or more.

2. The resin film with pressure-sensitive adhesive layer according to claim 1, wherein the inorganic oxide particles are particles where a polymerizable unsaturated group-containing organic compound bonded to the inorganic oxide particles.

3. The resin film with pressure-sensitive adhesive layer according to claim 1, wherein the inorganic oxide particles comprise silica particles.

4. The resin film with pressure-sensitive adhesive layer according to claim 1, wherein the oligomer blocking layer has a thickness of less than 1 μm.

5. The resin film with pressure-sensitive adhesive layer according to claim 1, further comprising a functional layer provided on a side of the first transparent resin film opposite to the first transparent resin film side where the oligomer blocking layer is provided.

6. The resin film with pressure-sensitive adhesive layer according to claim 5, wherein the functional layer includes a hard coating layer.

7. The resin film with pressure-sensitive adhesive layer according to claim 1, wherein the pressure-sensitive adhesive layer is an acrylic pressure-sensitive adhesive layer.

8. The resin film with pressure-sensitive adhesive layer according to claim 1, wherein the composition for forming the oligomer blocking layer contains 0.01 to 10 parts by weight of second particles with an average particle size of 300 nm to 2 μm other than the inorganic oxide particles based on 100 parts by weight of the curable compound, in addition to the curable compound and the inorganic oxide particles.

9. The resin film with pressure-sensitive adhesive layer according to claim 8, wherein the second particles have a refractive index difference of 0.1 or less from the average of the refractive indices of the curable compound and the inorganic oxide particles.

10. A laminated film comprising the resin film with pressure-sensitive adhesive layer according to claim 1 and a second transparent resin film bonded thereto with the pressure-sensitive adhesive layer of the resin film with pressure-sensitive adhesive layer interposed therebetween.

11. The laminated film according to claim 10, wherein the second transparent resin film is a transparent conductive film comprising a transparent conductive layer provided, directly or with an undercoat layer interposed therebetween, on one side of the second transparent resin film opposite to the second transparent resin film side where the pressure-sensitive adhesive layer is bonded.

12. A touch panel comprising the laminated film according to claim 11 including the transparent conductive film.
